(19) United States
(12) Patent Application Publication
(10) Pub. No.: US 2013/0125760 A1
(43) Pub. Date: May 23, 2013

(54) BATTERY BACKUP COFFEE MAKER

(71) Applicant: Denise Pitrucha, Welsh, LA (US)

(72) Inventor: Denise Pitrucha, Welsh, LA (US)

(21) Appl. No.: 13/300,637

(22) Filed: Nov. 20, 2011

(51) Int. Cl. A47J 31/00

(52) U.S. Cl. 99/285

(57) ABSTRACT

The present invention is a battery back-up coffee maker with a side that includes a coffee pot that is utilized in combination with the battery back-up coffee maker, an elongated transparent tube that fills with water that indicates a level of water in the water level gauge that indicates a water level of the battery back-up coffee maker and an LCD clock and timer display that displays a current time or a time each day that the battery back-up coffee maker activates an alarm. The coffee maker also includes a battery compartment that houses one or more batteries that serve as a back-up power source to the battery back-up coffee maker when currently provided power is terminated to the battery back-up coffee maker.

### TECHNICAL FIELD & BACKGROUND

Traditionally, when electrical shortages occur, household appliances that run on timers are often deprogrammed. Currently there are limited alternatives to coffee or tea makers which have the capacity to operate from an independent power source in the event of power failure.

The present invention generally relates to a coffee maker. More specifically, the invention is a battery back-up coffee maker.

It is an object of the invention to provide a battery back-up coffee maker that will provide power to the coffee maker during a loss of power to the coffee maker.

It is an object of the invention to provide a battery back-up coffee maker that is disposed directly on the coffee maker to provide auxiliary power to the coffee maker during a loss of power to the coffee maker.

What is really needed is a battery back-up coffee maker that will provide power to the coffee maker during a loss of power to the coffee maker that is disposed directly on the coffee maker to provide auxiliary power to the coffee maker during a loss of power to the coffee maker.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front side perspective view of a battery back-up coffee maker, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

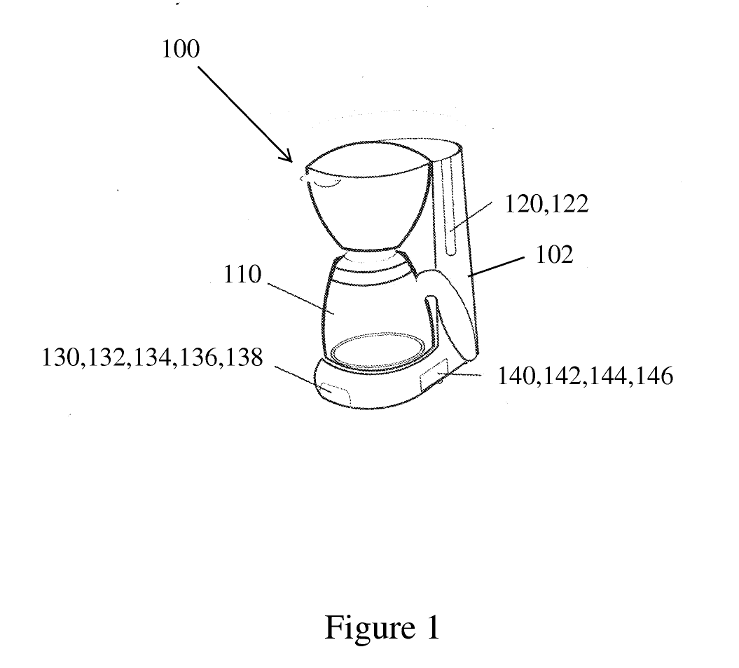

FIG. 1 illustrates a front side perspective view of a battery back-up coffee maker 100, in accordance with one embodiment of the present invention.

The battery back-up coffee maker 100 includes a coffee pot 110, a water level gauge 120, a clock and timer display 130 and a battery compartment 140. The coffee pot 110 can be any type of suitable coffee pot that is utilized in combination with the battery back-up coffee maker 100. The water level gauge 120 indicates a water level of the battery back-up coffee maker 100. The water level gauge 120 is an elongated transparent tube 122 that fills with water that indicates the relative level of water in the water level gauge. Other suitable water level gauge types can also be incorporated into the battery back-up coffee maker 100. The water level gauge 120 as illustrated in FIG. 1 is disposed on a side 102 of the battery back-up coffee maker 100, although the water level gauge 120 can be disposed on any suitable area of the battery back-up coffee maker 100. The clock and timer display 130 displays the current time 132 or timer related information such as a time 134 each day that the battery back-up coffee maker 100 activates an alarm 136. The clock and timer display 130 can be any suitable type of display such as an LCD display 138 or other suitable digital display or analog display. The battery compartment 140 houses one or more batteries 142 that are activated and serve as a back-up power source for the battery back-up coffee maker 100 if currently provided power is terminated to the battery back-up coffee maker 100. The batteries 142 housed in the battery compartment 140 can be any suitable number and type of batteries such as standard alkaline batteries 144, lithium batteries 146 or other suitable size of batteries. The battery back-up coffee maker 100 is made of plastic and/or metal materials, although the battery back-up can be made of other suitable materials as well.

Made of plastic and metal, the battery back-up coffee maker incorporates a compartment encompassing batteries to power the appliance should electricity provided to the battery back-up coffee maker be unavailable. The battery back-up coffee maker remains active during a loss of power, ensuring coffee will be obtainable during the power loss. The design of the battery back-up coffee maker is very useful and permits timed appliances to reliably provide coffee or tea at conveniently scheduled times. Able to afford individuals the luxury of readily accessible beverages such as coffee and tea during a power loss, the battery backup coffee maker is available in various colors and designs at retail various household stores. The battery backup coffee maker also provides an alternate power source. The design features a battery compartment, allowing coffee and tea makers to continue to operate and produce beverages on time even in the event of electrical power failure.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A battery back-up coffee maker with a side, comprising:
a coffee pot that is utilized in combination with said battery back-up coffee maker;
a water level gauge that indicates a water level of water in said battery back-up coffee maker;
a clock and timer display that displays a current time or a time each day that said battery back-up coffee maker activates an alarm; and
a battery compartment that houses one or more batteries that serve as a back-up power source to said battery back-up coffee maker.

2. The coffee maker according to claim 1, wherein said water level gauge is an elongated transparent tube that fills with water that indicates a level of water in said water level gauge.

3. The coffee maker according to claim 1, wherein said water level gauge is disposed on said side of said battery back-up coffee maker.

4. The coffee maker according to claim 1, wherein said clock and timer display is an analog display.

5. The coffee maker according to claim 1, wherein said clock and timer display is a digital display.

6. The coffee maker according to claim 1, wherein said batteries housed in said battery compartment are activated when currently provided power is terminated to said battery back-up coffee maker.

7. A battery back-up coffee maker with a side, comprising:
a coffee pot that is utilized in combination with said battery back-up coffee maker;
a water level gauge that indicates a water level of water in said battery back-up coffee maker;
a digital clock and timer display that displays a current time or a time each day that said battery back-up coffee maker activates an alarm; and
a battery compartment that houses one or more batteries that serve as a back-up power source to said battery back-up coffee maker, wherein said batteries housed in said battery compartment are activated when currently provided power is terminated to said battery back-up coffee maker.

8. The coffee maker according to claim 7, wherein said water level gauge is an elongated transparent tube that fills with water that indicates a level of water in said water level gauge.

9. The coffee maker according to claim 7, wherein said water level gauge is disposed on said side of said battery back-up coffee maker.

10. The coffee maker according to claim 7, wherein said clock and timer display is an analog display.

11. The coffee maker according to claim 7, wherein said clock and timer display is an LCD display.

12. The coffee maker according to claim 7, wherein said batteries are one or more standard alkaline batteries.

13. A battery back-up coffee maker with a side, comprising:
a coffee pot that is utilized in combination with said battery back-up coffee maker;
an elongated transparent tube that fills with water that indicates a level of water in said water level gauge that indicates said water level of said battery back-up coffee maker;
an LCD clock and timer display that displays a current time or a time each day that said battery back-up coffee maker activates an alarm; and
a battery compartment that houses one or more batteries that serve as a back-up power source to said battery back-up coffee maker, wherein said batteries housed in said battery compartment are activated when currently provided power is terminated to said battery back-up coffee maker.

14. The coffee maker according to claim 13, wherein said water level gauge is disposed on said side of said battery back-up coffee maker.

15. The coffee maker according to claim 13, wherein said clock and timer display is an analog display.

16. The coffee maker according to claim 13, wherein said batteries are one or more alkaline batteries.

17. The coffee maker according to claim 13, wherein said batteries are one or more lithium batteries.

18. The coffee maker according to claim 13, wherein said battery back-up coffee maker is made of plastic material.

19. The coffee maker according to claim 13, wherein said battery back-up coffee maker is made of metal.

20. The coffee maker according to claim 19, wherein said battery back-up coffee maker is made of metal and plastic material.
